(19) United States
(12) Patent Application Publication
(10) Pub. No.: US 2018/0345738 A1
(43) Pub. Date: Dec. 6, 2018

(54) Adapter For Rolling Assembly And Rolling Assembly Comprising Same

(71) Applicant: COMPAGNIE GENERALE DES ETABLISSEMENTS MICHELIN, Clermont-Ferrand (FR)

(72) Inventors: Daniel WALSER, Clermont-Ferrand Cedex 9 (FR); Antonio DELFINO, Clermont-Ferrand Cedex 9 (FR)

(21) Appl. No.: 15/780,563

(22) PCT Filed: Oct. 24, 2016
(86) PCT No.: PCT/EP2016/075544

§ 371 Date: May 31, 2018

(30) Foreign Application Priority Data
Dec. 1, 2015 (FR) 1561644

(51) Int. Cl. B60C 15/02; B60B 21/12

(52) U.S. Cl. CPC B60C 15/023; B60B 2900/351; B60B 21/12; B60C 15/0203

(57) ABSTRACT

Adapter for a tire having two beads (B) and a rim (J) placed between one of the beads and the rim, the rim having two rim seats (7). The adapter has an axially inner end (10) mounted on rim seat (7) and comprises inner reinforcer element (16). Axially outer end (9) is mounted on rim seat (7), and comprises outer reinforcer element (15), body (11) that connects outer end (9) to inner end (10) so as to form a single piece. A substantially cylindrical adapter seat receives one of the beads (B). Adapter bearing face (21) is substantially contained in a plane perpendicular to the axis. Outer reinforcer element (15) is wholly positioned axially on the outside of bearing face (21). Body (11) comprises at least one isotropic material (23, 24) selected from polyurethane, nylon, polyethylene terephthalate, polybutadiene terephthalate, silicones.

The invention relates to an adapter for a rolling assembly formed mainly of a tire and of a rim, and to a rolling assembly comprising the said adapter.

A reminder of the definitions used in the present invention is given below:
“axial direction”: direction parallel to the axis of rotation of the tire,
“radial direction”: direction intersecting the axis of rotation of the tire and perpendicular thereto,
“circumferential direction”: direction perpendicular to a radius and comprised in a plane perpendicular to the axis of rotation of the tire,
“radial section”: section in a plane containing the axis of rotation of the tire,
“equatorial plane”: plane perpendicular to the axis of rotation and passing through the middle of the tread.

Insertion of an elastic adapter between the rim and the beads of a tire is already known from the application WO00/78565. This adapter is elastically deformable in the radial and axial directions. Such an adapter makes it possible to separate that part of the rolling assembly that can be considered to actually act as a tire from that part of the rolling assembly that can be considered to act as a rim.

However, although such an assembly also makes it possible to ensure the functions of a conventional tire, notably a drift thrust response of the tire following the application of a drift angle to the tire, thereby giving the assembly sufficient flexibility for it to avoid any surface deterioration or depth deterioration, it does not perfectly ensure sufficient deformability of the tire in the event of impacts with kerbs or holes in the roadway, such as potholes.

This is because the assembly mounted with the adapter of the prior art does not make it possible to obtain a local deformation in the region of the contact patch. The teaching of that document also has the drawback of not making it easily possible to obtain embodiments of the adapter that afford a high capability of absorbing large deformations on passing through potholes without residual plastic deformations.

That document gives no suggestions for architectural adaptations which would lead to an outer reinforcer deformation that is localized in the region of the contact patch resulting in a reduced camber and thus making the mounted assembly less intrusive with regard to the vehicle.

An adapter disposed between the rim and each bead of a tire and intended to make it easier to mount/remove the latter is also known from the document FR2,491,836. That adapter mainly comprises two annular bead wires that are spaced apart from one another and mounted inside an annular body comprising a ply. The bead wires are connected by a reinforcer which, moreover, surrounds them. That adapter allows mounting on a greater rim diameter with the same axial spacing of the beads.

Therefore, there remains a need to have a novel adapter which ensures better protection of the tire in the event of impacts with the tire that are due to use on roads in poor condition, thereby minimizing as far as possible partial or even total damage to its internal structure, while keeping the roadholding performance of the tire at a high level, in particular its ability to develop high drift thrusts. Moreover, at the very least, in the event of damage due to unusually harsh use, it is a question of keeping the vehicle safe through its movement over a short distance following an impact that destroys the assembly.

The subject of the invention is thus an adapter for a rolling assembly having an axis of rotation and comprising:
a tire having two beads, and
a rim,
   the said adapter providing the connection between one of the beads and the rim, the said rim having two rim seats,
   the said adapter having:
an axially inner end that is intended to be mounted on a rim seat and comprises an inner reinforcing element,
an axially outer end that comprises an outer reinforcing element,
a body that connects the said outer end to the said inner end so as to form a single piece and comprises at least one main reinforcement that provides the connection between the said outer reinforcer and the said inner reinforcer,
a substantially cylindrical adapter seat intended to receive one of the said beads, the said seat being situated at the axially outer end of the said body,
an adapter bearing face substantially contained in a plane perpendicular to the axis of rotation, the said bearing face being situated on the axially inner face of the axially outer end.

The reinforcing element of the axially outer end is wholly situated axially on the outside of the bearing face without being connected to the said bearing face. The body may comprise, facing the adapter seat, an annular seat reinforcer.

The adapter is characterized in that the body comprises at least one isotropic material selected from polyurethane, nylon, polyethylene terephthalate, polybutadiene terephthalate, silicones.

The isotropic material may be arranged continuously or discontinuously.

According to the invention, the reinforcing element of the axially outer end is independent of the annular seat reinforcer.

The axially outer part of the axially outer end may take various geometric forms.

The adapter according to the invention has the advantage of being of simple make-up, easy to assemble, and of allowing tire/adapter/rim to be assembled easily. Moreover, owing to the increase in clamping under the beads of the tire, the adapter according to the invention makes it possible to prevent the rotation thereof on the adapter under high torque loadings.

Finally, the adapter according to the invention has the advantage of significantly reducing the level of mechanical forces towards the chassis in the event of an impact, and thus of making it possible to make the vehicle bodyshell and wheel lighter. Finally, a last advantage of this adapter is that it raises the threshold for mechanical breakage of the wheel in the event of impacts.

The flexible adapters known to date have been made up of an assembly of textile threads coated in elastomeric compound. These threads are arranged in several layers in different directions and pass around the reinforcers of the radially inner and radially outer ends of the adapter, before being folded back down onto themselves. Such make-ups (threads/elastomer) form a ply similar to that of which tires are formed, which is good at withstanding the tensile forces generated by the mechanical pressure exerted during running, or simply after inflation, even though such a make-up exhibits different stiffnesses according to the direction of loading.

Thus, the inflating of a mounted assembly comprising at least one adapter leads to tensions which give rise to small deformations in transverse directions. Specifically, it has been found that, upon inflation, the additional presence of two adapters causes rotation about a radial axis of the contact patch in which the tire is in contact with the ground. This phenomenon can be explained by the fact that one adapter causes the tire to rotate slightly, in the clockwise direction about the axis of the wheel, while the other adapter, through the effect of symmetry, causes the tire to rotate in the other direction.

Such a small rotation of the contact patch is the equivalent of the application of a small steering angle caused by the plies having different rigidities according to the direction of loading applied to the adapter.

This phenomenon disappears when the adapter is made of at least one isotropic material.

Furthermore, the isotropic material makes it possible, on the one hand, to give the adapter according to the invention its definitive overall shape and, on the other hand, to transmit the mechanical load between the tire and the rim, and finally to improve comfort in the vehicle interior by reducing unwanted noise.

The isotropic material placed in contact with the rim preferably has a rigidity suited to ensuring an airtight seal between the adapter and the rim, once fitted.

This type of material also preferably has compatibility with the clamping pressures usually applied in this region of the mounted assembly, and correct creep behaviour.

The materials hitherto used in known adapters (plies) exhibit anisotropic behaviour, leading to different stiffness characteristics according to the direction of the mechanical loading. This phenomenon causes deformations of the adapter and, therefore, of the contact patch in which the tire is in contact with the ground, and as a result has a negative influence on the handling of the vehicle.

The isotropic material according to the invention avoids such effects occurring.

In addition, the use of an isotropic material having an elastic modulus at 10% strain (MA10) of between 30 and 50 MPa, which is higher than that of an elastomeric composition which is comprised between 3 and 10 MPa, in the adapter according to the invention, makes it possible to improve the ability of the mounted assembly to withstand the compression forces to which the mounted assembly is subjected.

What is meant by the elastic modulus of a material is the secant extension modulus obtained under tension in accordance with standard ASTM D 412, 1998 (test specimen “C”): the apparent secant modulus values at 10% elongation, denoted “MA 10” and expressed in MPa (under standard temperature and relative humidity conditions in accordance with the ASTM D 1349 standard of 1999), are measured in second elongation (that is to say after an accommodation cycle). This elastic modulus is to be distinguished from the elastic modulus values obtained in compression and the values of which generally have no bearing on the modulus values obtained in extension.

Another subject of the invention is a rolling assembly having an axis of rotation and comprising:
a tire having two beads,
a rim,
at least one adapter providing the connection between one of the beads and the rim,
   the said rim having two rim seats as defined hereinabove,
   the said adapter having:
an axially inner end that is intended to be mounted on a rim seat and comprises an inner reinforcing element,
an axially outer end that comprises an outer reinforcing element,
a body that connects the said outer end to the said inner end so as to form a single piece and comprises at least one main reinforcement that provides the connection between the said outer reinforcer and the said inner reinforcer,
a substantially cylindrical adapter seat intended to receive one of the said beads, the said seat being situated at the axially outer end of the said body,
an adapter bearing face substantially contained in a plane perpendicular to the axis of rotation, the said bearing face being situated on the axially inner face of the axially outer end.

The reinforcing element of the axially outer end is wholly situated axially on the outside of the bearing face without being connected to the said bearing face. The body may comprise, facing the adapter seat, an annular seat reinforcer.

This rolling assembly is characterized in that the body comprises at least one isotropic material selected from polyurethane, nylon, polyethylene terephthalate, polybutadiene terephthalate, silicones.

The adapter allows a rolling assembly to have sufficient radial deformations between the bead of the tire and the rim, during its use and while it is inflated to a nominal pressure, to promote the desired protection with regard to lateral impacts.

The axially outer end of the adapter axially delimits a “housing intended to accept the bead of the tire”. The bearing face of the axially outer end serves to support, in the axial direction, the bead of the tire in the manner of a rim flange.

Thus, the housing accommodates the bead of the tire in exactly the same way as the seat of a rim conventionally would. The tire is therefore axially immobilized by the inflation pressure and is pressed firmly against the bearing face of this axially outer end, in the manner of what happens conventionally in the case of the bead of a tire against the rim flange of a rim.

The axially inner end of the adapter may be denoted “adapter bead” since it is intended to couple the adapter to the rim flange of a rim in the same way as is conventionally done by the bead of a tire.

Thus, when the rolling assembly according to the invention is in operation and at the service loadings for which it is designed, the tire is immobilized axially with respect to the rim, more specifically the beads of the tire are immobilized axially with respect to the rim in the same way as in a conventional rolling assembly in which the beads of the tire are mounted directly on the seats of a rim, while the beads of the tire are not radially immobilized with respect to the rim, more specifically the beads of the tire are capable of moving radially to some extent with respect to the rim. In standard running, it may be said that there is practically no axial deformation of the adapter, or else that such deformation is negligible with respect to the radial deformation.

By contrast, in a knock, the axial deformation of the adapter may be great, thus contributing to reducing the stress loadings on the mounted assembly.

The reinforcing element of the axially outer end is disposed radially on the outside of the adapter seat. Preferably, a first and a second adapter each have a body with a different or identical length.

For preference, the body comprises a first and a second isotropic material, it being possible for the first and second isotropic materials to be of identical or different chemical natures.

The adapter may comprise a third isotropic material. This third material may be a foam that absorbs tire cavity noise.

For preference, the first and second isotropic materials exhibit a modulus at 10% strain (MA10) of between 25 MPa and 800 MPa independently of one another.

For preference, the first isotropic material envelops the inner and outer reinforcing elements, and the second isotropic material covers all or part of the first isotropic material.

For preference, when two isotropic materials are present, the first material has a modulus at 10% strain (MA10) of between 250 MPa and 800 MPa, and the second material exhibits a modulus at 10% strain (MA10) of between 25 MPa and 50 MPa.

In such a case, the second material would have the function of protecting the first material from external attack and of allowing easier sealing between the adapter and the tire on the one hand, and between the adapter and the rim on the other hand, in the face of variations in geometry.

The second isotropic material would also contribute to grip between the tire, the adapter and the tire. This would make it possible to avoid relative slip under braking.

The particular choice of the second material would make it possible to absorb a maximum amount of noise energy within the tire and thus reduce the tire cavity noise.

The second material could have a rigidity ranging from 10 to 30 times lower than that of the first material enveloping the inner and outer reinforcing elements.

Preferably, the annular seat reinforcer has a compression modulus greater than or equal to 1 GPa, and preferably greater than 4 GPa, and more preferably greater than 10 GPa. The annular reinforcer may be made up of a core surrounded by an elastomer, or of a succession of layers of elastomeric compounds and metal and/or textile reinforcers positioned in any possible combination. The core may comprise at least one element selected from a metal, a composite material, a thermoplastic, and a mixture thereof. The composite material may be based on glass fibres embedded in a resin matrix.

The list of elastomers that can be used includes, firstly, rubbers that are crosslinkable by chemical vulcanization reactions by sulfur bridges, by carbon-carbon bonds created by the action of peroxides or of ionizing radiation, by other specific atom chains of the elastomer molecule, secondly, thermoplastic elastomers (TPEs) in which the elastically deformable part forms a network between rather non-deformable “hard” regions, the cohesion of which is the product of physical connections (crystallites or amorphous regions above their glass transition temperature), and next non-thermoplastic elastomers and finally thermosetting resins.

The annular seat reinforcer may be made up of at least two layers of different constituents positioned successively and in alternation. Positioned in alternation means successive disposition of a first layer and then a second layer, several times.

The annular seat reinforcer may have an overall axial length greater than or equal to 30% of the width of the bead of the tire, and less than 150% of this same width, and more preferably between 40 and 110% of the width of the bead of the tire.

The annular seat reinforcer may have a mean radial thickness greater than or equal to 0.3 mm and less than or equal to 20 mm depending on the size and the use of the tire. Thus, for a passenger vehicle tire, the thickness is preferably between 0.5 and 10 mm.

The annular seat reinforcer preferably comprises at least one element selected from a metal, a composite material, a thermoplastic, and a mixture thereof. This core or this multilayer is preferably comprised between two layers of a matrix comprising the choice of an elastomer as cited above, a resin or a mixture thereof.

The annular seat reinforcer preferably consists of a stack of different layers of elastomer compounds with identical or different chemical natures.

When it is in the form of a stack of layers, the reinforcer preferably has an axial length greater than 5 mm and less than 25 mm and a radial thickness greater than or equal to 0.1 mm and less than or equal to 4 mm.

Each single element of which the stack of the reinforcer is made may have an axial width greater than 1 mm and less than 25 mm and an identical or different radial thickness greater than or equal to 0.1 mm and less than or equal to 2 mm.

The annular seat reinforcer may also be in the form of a stack of single threads between a layer of a matrix comprising the choice of an elastomer, a thermoplastic compound, a resin, or mixtures thereof. The single threads may be threads that are conventionally used, such as textile threads (polyester, nylon, PET, aramid, rayon, natural fibres (cotton, flax, hemp)), metal threads, composite threads (carbon, glass-reinforced resin), or mixtures of these constituents.

The annular seat reinforcer may also be in the form of one or more plies, the reinforcers of which are positioned at an angle of between 0 and 90° with respect to the circumferential direction of the tire.

Preferably, the annular reinforcer may be positioned radially on the outside or radially on the inside of the body of the adapter, on either side of the said body, or else between the plies of reinforcing elements of the body of the adapter.

The outer and inner reinforcing elements may, independently of one another, consist of metal (steel), nylon, PET or aramid. The annular reinforcement may comprise a matrix of resin and/or reinforcing fibres, such as rayon, aramid, PET, nylon, glass fibre, carbon fibre, basalt fibre, poly(ethylene 2,6-naphthalate) (PEN), polyvinyl alcohol (PVA).

The main reinforcement of the said body may have a modulus greater than or equal to 4 GPa; it may consist of metal (steel), of textile cord (rayon, aramid, PET, nylon, glass fibre, carbon fibre, basalt fibre, poly(ethylene 2,6-naphthalate) (PEN), or polyvinyl alcohol (PVA)).

Preferably, the adapter may be positioned on just one side of the rim, and preferably on the outboard side of the vehicle. In this case, the rim has an asymmetrical geometric shape so as to suit there being an adapter present on just one side.

The axial length L of the body of the adapter according to the invention may be greater than 2.54 cm and less than 8 cm, and preferably greater than 3.17 cm and less than 5.10 cm.

When the mounted assembly comprises two adapters, the latter may be symmetrical or non-symmetrical. The concept of symmetry or asymmetry of the adapter is defined by the axial length of the body of the adapter. Two adapters are asymmetrical when the body of one of them has an axial length greater than that of the other.

On mounting, the adapter is first of all mounted on the rim flange and then, in a second phase, the tire is mounted and fitted on the outer end of the adapter. During this mounting operation, an outward protrusion (also referred to as “hump”) may become formed on the body of the adapter. The appearance of this hump improves the fitting of the assembly on the rim flange.

Preferably, the rolling assembly according to the invention comprises a first and a second adapter that each have a body with a different or identical length.

The first and second materials may have identical or different colours.

The collection of materials selected from which to form the adapter according to the invention are selected in such a way as to allow conduction of electricity between the ground and the wheel, and therefore between the ground and the vehicle. Assuming that one or more materials used are unable to provide this conductivity, it is possible to add to the structure of the adapter any constituent known in the field of tires to provide this effect.

The invention will now be described with the aid of examples and figures which follow and which are given purely by way of illustration, and in which:

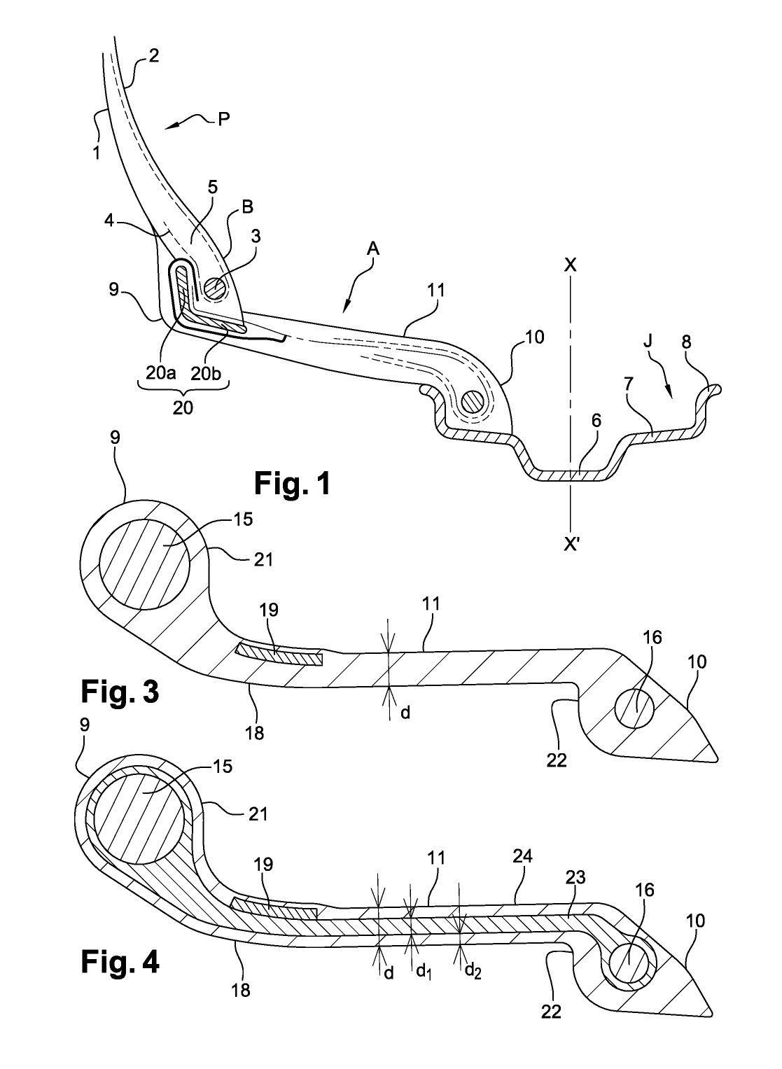

FIG. 1 schematically depicts the adapter according to the prior art,

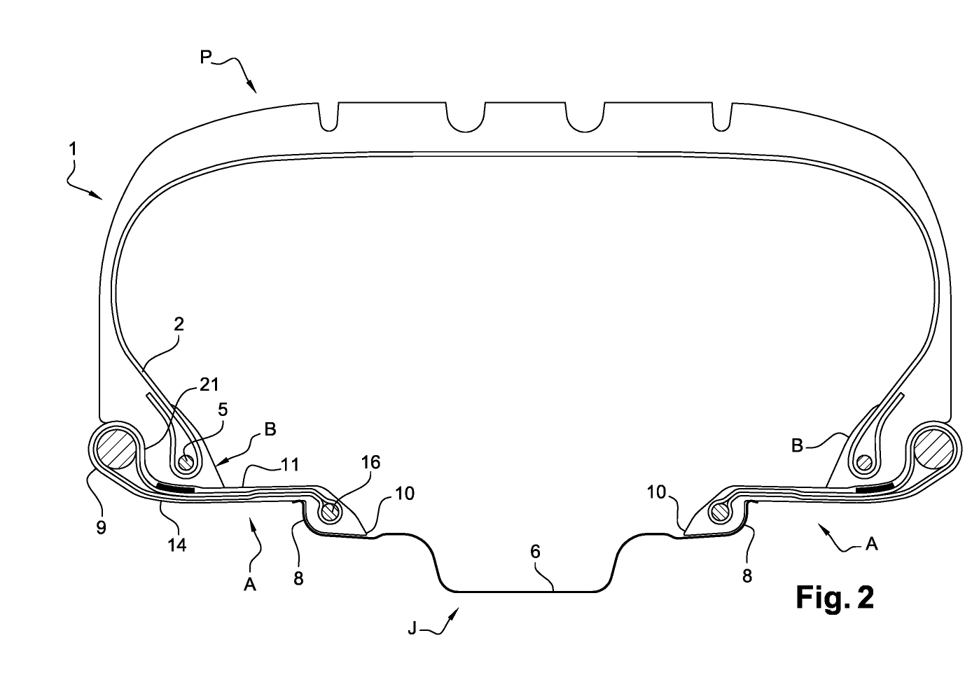

FIG. 2 depicts, schematically and in radial section, a tire mounted on two adapters according to the invention, which are themselves fitted on the rim in a removable manner,

FIG. 3 depicts a schematic view, in radial section, of a non-mounted adapter according to a first alternative form of the invention,

FIG. 4 depict a schematic view, in radial section, of a non-mounted adapter according to a second alternative form of the invention,

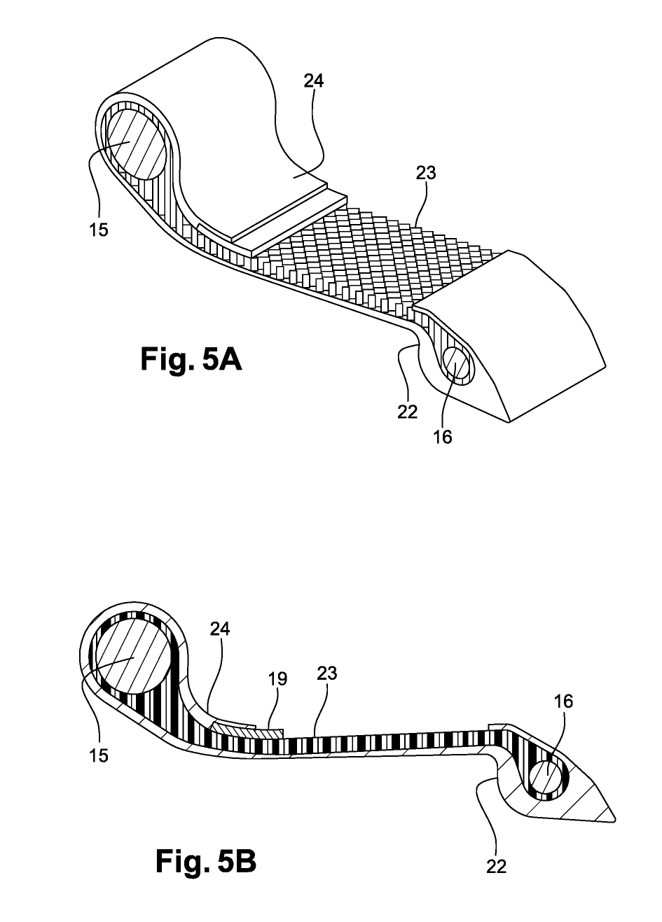

FIGS. 5A and 5B depict the adapter according to a third alternative form, in perspective and in section, respectively.

FIG. 1, which depicts an adapter according to the prior art, comprises a tire P (partially depicted), an adapter A and a rim J.

The tire, of which the design per se is unaltered in the invention, is formed of a tread reinforced by a crown reinforcement joined to two beads B on either side of an equatorial plane XX′ by way of two sidewalls 1. A carcass reinforcement 2 that mainly reinforces the sidewalls 1 is anchored in each bead B to at least one bead wire, in this case of the “braided” type 3, so as to form turn-ups 4 that are separated from the main part of the carcass reinforcement by profiled elements 5 having a quasi triangular shape.

It is important to note that the invention can be implemented with a very large number of types of tire, be they radial tires or cross-ply tires, or even with tires of the type having self-supporting sidewalls.

The rim J comprises a groove 6, known as a mounting groove, that connects, on either side of the equatorial plane, two rim seats 7 that are axially extended by rim flanges 8, the radially outer edges of which are curved over.

The adapter A mainly comprises an axially outer end 9, an axially inner end 10 and a body 11 connecting the said end 9 to the said end 10.

The axially outer end 9 comprises an outer reinforcing element 20 made up of a first portion 20a that is connected to a second portion 20b that between them form a substantially perpendicular angle. During the mounting of the tire, the bead seat for the bead B is fitted into the space created by this outer reinforcing element 20.

FIG. 2 depicts a mounted assembly comprising two adapters A according to the invention that connect the beads B of the tire P to the two rim flanges 8 of the rim J. The adapters in this FIG. 2 are detachable from the rim J and from the beads B of the tire.

The adapter A, which is positioned at each bead B of the tire, may be symmetrical or non-symmetrical. Symmetry is defined as meaning that the overall length of the body 11 is identical on the two adapters. When the assembly (tire, rim and adapter) is mounted, the beads B of the tire are positioned on the adapter seat 14 and made to bear axially against a bearing face 21.

FIG. 3 depicts an adapter according to the invention which is not mounted on a rim. This adapter comprises, on one side, an axially outer end 9 with an outer reinforcer 15 having a substantially spherical geometric shape in section, consisting of a composite material such as glass-fibre-reinforced plastic, and, on the other side, an axially inner end 10 with a metal reinforcer 16, and finally a body 11 made of an isotropic material, polyurethane.

The body 11 comprises a substantially cylindrical adapter seat 18 that is intended to receive a bead of the tire that is disposed at the axially outer end of the body 11. The total thickness “d” of the body 11 is approximately 6 mm.

The body 11 also comprises an adapter bearing face 21 that is contained substantially in a plane perpendicular to the axis of rotation, is situated on the axially inner face of the axially outer end, and is intended to keep the bead in place in its housing. This adapter seat 18 comprises an annular seat reinforcer 19 that has a compression modulus equal to 100 GPa. According to the depiction in this FIG. 3, the entirety of the reinforcer 19 is positioned at the radially outer surface of the surface of the body 11.

The body 11 has a length of about 3.175 cm (1.25 inches). This length is measured between the bearing face 21 and the axially outer lip 22 of the axially inner end 10.

In contrast to the known device (FIG. 1), the annular seat reinforcer 19 is not secured to the outer reinforcer 15. These two reinforcers 19, 15 are entirely independent of one another.

The reinforcer 19 is made up of a tri-layer comprising metal reinforcers in the form of wires, alternating with an elastomer of the rubber-resin type. The reinforcer 19 has a radial thickness of about 1.5 mm and an axial length of about 15 mm.

The elastomer layer of the reinforcer 19 has a radial thickness of about 0.3 mm and an axial length of about 15 mm.

A layer of elastomer 20 covers all of the elements that make up the adapter, namely the reinforcer 15, the reinforcer 16, the body 11 and the radially outer surface of the reinforcer 19.

FIG. 4 differs from FIG. 3 by the presence of two isotropic materials in the body 11. The first material 23, which is polyethylene terephthalate, is positioned in such a way as to connect the two, outer 15 and inner 16, reinforcers. This first material 23 has a modulus at 10% strain (MA10) of 500 MPa. The second material 24, which is polyurethane, is positioned in such a way as to cover the entirety of the first material 23. The second material 24 has a modulus at 10% strain (MA10) of 30 MPa.

The total thickness “d” of the body 11 is comprised between 3 and 4 mm. The thickness “d₁” of the first material 23 is comprised between 2 and 3 mm. The thickness “d₂” of the second material 24 is comprised between 0.5 and 1 mm.

According to another alternative form (not depicted), the second material 24 may be positioned in such a way as to cover just part of the first material 23, and preferably that part of the adapter that is visible from the outside of the vehicle, this being for aesthetic reasons. The second material may also cover only that part of the adapter in contact with the rim or the tire, this being for functional reasons.

FIGS. 5A and 5B show that the first material 23 is arranged discontinuously and that it is covered with the second material 24 arranged continuously.

The following examples show the results obtained with the adapter according to the invention.

### EXAMPLE 1: KERBING TESTS

This test involves causing a mounted assembly to mount a kerb, at a defined speed, at an angle of attack of 30°. This choice of angle is based on the fact that it represents a loading that is very penalizing to a tire. The test is performed with two different kerb heights (90 mm and 110 mm).
The test proceeds as follows. Several passes are made with the wheel at different speeds until the tire becomes punctured. The starting speed is 20 km/h and then the speed is incremented by 5 km/h on each new pass.
A conventional assembly without an adapter (control 1) is compared against an assembly fitted with an adapter according to document WO00/78565 (control 2) and against an assembly fitted with an adapter according to the invention (invention). These assemblies are all of the size 205/55R16 comprising a 6.5J16 rim. The results are collated in the following Table I and are given in percent:

TABLE I

| | Control 1 | Control 2 | Invention |
|---|---|---|---|
| Percentage of the puncturing speed | 100 | >150 | >150 |
| compared with control - kerb height | | | |
| 90 mm | | | |
| Level of vertical thrust force (Fz) | 100 | 50 | 45 |
| recorded at the puncturing speed for | | | |
| Control 1 | | | |

The test performed on the kerb height of 90 mm leads to the control tire puncturing at a speed of 30 km/h, whereas the assembly according to the invention suffers no damage at this same speed, or even at a speed of 50 km/h.
The test performed on the kerb height of 110 mm leads to the control tire puncturing at a speed of 20 km/h, whereas the assembly according to the invention suffers no damage at this same speed, or even at a speed of 40 km/h.

### EXAMPLE 2: MAINTAINING OVERALL RIGIDITY WHILE REDUCING TOTAL MASS

When an adapter is dimensioned in accordance with the invention, it is necessary to take into consideration the overall vertical rigidity of the mounted assembly which comprises this adapter. In the case of an adapter containing polyurethane as its only isotropic material, the adapter obtained has a total thickness of 6 mm and weighs 940 g, excluding the mass of the reinforcers.

In the case of an adapter containing polyethylene terephthalate as its first material with a thickness d₁ of 2 mm, and polyurethane as its second material with a thickness d₂ of 0.5 mm, the object obtained has a total thickness d of 3 mm, and weighs 700 g, excluding the mass of the reinforcers.

When the total thickness is 4 mm, the adapter has a weight of 765 g, excluding the mass of the reinforcers.

### EXAMPLE 3: VERTICAL RIGIDITY MEASUREMENT

This example involves measuring the vertical rigidity of a mounted assembly comprising an adapter according to the invention. This adapter comprises a single isotropic material (polyurethane) having a modulus at 10% strain (MA10) comprised between 30 and 50 MPa, a glass fibre reinforced plastic composite as outer reinforcing element, having a modulus at 10% strain (MA10) of 40 000 MPa in the direction of the glass fibres, a modulus at 10% strain (MA10) of 4000 MPa in the other two dimensions, and a shear modulus of 2500 MPa.

This measurement consists in estimating the deflection of an adapter rigidly immobilized, in contact with the rim and subjected to a force of 250 daN

The deflection lies at around 9 mm (which corresponds to a secant rigidity of 27.5 daN/mm per adapter, namely 55 daN/mm for two adapters).

The deformation of the polyurethane remains limited, and represents approximately 11%.

1. An adapter for a rolling assembly having an axis of rotation and comprising:
a tire having two beads,
a rim,
the adapter providing the connection between one of the beads and the rim,
the rim having two rim seats,
wherein the adapter comprises:
an axially inner end adapted to be mounted on a rim seat and comprises an inner reinforcing element;
an axially outer end that comprises an outer reinforcing element;
a body that connects said axially outer end to said axially inner end so as to form a single piece and comprises at least one main reinforcement that provides the connection between said outer reinforcing element and said inner reinforcing element;
a substantially cylindrical adapter seat adapted to receive one of the beads, said seat being situated at the axially outer end of said body; and
an adapter bearing face substantially contained in a plane perpendicular to the axis of rotation, said bearing face being situated on the axially inner face of the axially outer end,
wherein the reinforcing element of the axially outer end is entirely situated axially outside said adapter bearing face without being connected to said adapter bearing face, and
wherein the body comprises at least one isotropic material selected from polyurethane, nylon, polyethylene terephthalate, polybutadiene terephthalate, silicones.

2. The adapter according to claim 1, wherein the body comprises a first and a second isotropic material.

3. The adapter according to claim 2, wherein the first and second isotropic materials are of identical chemical natures.

4. The adapter according to claim 2, wherein the first and second isotropic materials are of different chemical natures.

5. The adapter according to claim 1, wherein the first and second materials exhibit a modulus at 10% strain (MA10) of between 25 MPa and 800 MPa independently of one another.

6. The adapter according to claim 1, wherein the first isotropic material envelops the inner and outer reinforcing elements.

7. The adapter according to claim 1, wherein the second isotropic material covers all or part of the first isotropic material.

8. The adapter according to claim 1, wherein when two isotropic materials are present, the first has a modulus at 10% strain (MA10) of between 250 MPa and 800 MPa, and the second material exhibits a modulus at 10% strain (MA10) of between 25 MPa and 50 MPa.

9. The adapter according to claim 1, wherein the body comprises an annular seat reinforcer (19) facing the adapter seat.

10. The adapter according to claim 1, wherein the reinforcing element of the axially outer end is selected from metal, nylon, polyethylene, aramid, and composite materials.

11. The adapter according to claim 1, wherein the reinforcing element of the axially inner end is selected from metal, nylon, polyethylene, aramid, and composite materials.

12. The adapter according to claim 10, wherein the composite material is made from glass fibres embedded in a resin material.

13. The adapter according to claim 1, wherein the body has an axial length greater than 2.54 cm and less than 8 cm.

14. The adapter according to claim 9, wherein the body has an axial length greater than 3.17 cm and less than 5.10 cm.

15. A rolling assembly having an axis of rotation and comprising:
a tire having two beads,
a rim,
at least one adapter providing the connection between one of the beads and the rim, according to claim 1,
the rim having two rim seats,
wherein the adapter comprises:
an axially inner end adapted to be mounted on a rim seat and comprises an inner reinforcing element;
an axially outer end that comprises an outer reinforcing element;
a body that connects said axially outer end to said axially inner end so as to form a single piece and comprises at least one main reinforcement that provides the connection between said outer reinforcing element and said inner reinforcing element,
a substantially cylindrical adapter seat adapted to receive one of the beads, the said seat being situated at the axially outer end of the said body; and
an adapter bearing face substantially contained in a plane perpendicular to the axis of rotation, said adapter bearing face being situated on the axially inner face of the axially outer end,
wherein the reinforcing element of the axially outer end is entirely situated axially outside the bearing face,
wherein the body comprises at least one isotropic material selected from polyurethane, nylon, polyethylene terephthalate, polybutadiene terephthalate, silicones.

16. The rolling assembly according to claim 15, wherein a first and a second adapter each have a body with an identical or different length.

17. The rolling assembly according to claim 15, wherein the body comprises two isotropic materials.

18. The rolling assembly according to claim 15, wherein the two isotropic materials are of identical chemical natures.

19. The rolling assembly according to claim 16, wherein the two isotropic materials are of different chemical natures.

20. The rolling assembly according to claim 15, wherein the body has an axial length greater than 2.54 cm and less than 8 cm.

21. The rolling assembly according to claim 15, wherein the body has an axial length greater than 3.17 cm and less than 5.10 cm.

22. The rolling assembly according to claim 15, wherein the reinforcing element of the axially outer end is selected from metal, nylon, polyethylene, aramid, and composite materials.

23. The rolling assembly according claim 15, wherein the reinforcing element of the axially inner end is selected from metal, nylon, polyethylene, aramid, and composite materials.
